(19) United States
(12) Patent Application Publication
(10) Pub. No.: US 2018/0175937 A1
(43) Pub. Date: Jun. 21, 2018

(54) SIGNAL TRANSMISSION METHOD, APPARATUS, AND SYSTEM

(71) Applicant: Huawei Technologies Co., Ltd., Shenzhen (CN)

(72) Inventor: Sulin Yang, Shenzhen (CN)

(21) Appl. No.: 15/898,099

(22) Filed: Feb. 15, 2018

Related U.S. Application Data
(63) Continuation of application No. PCT/CN2015/087234, filed on Aug. 17, 2015.

(51) Int. Cl. H04B 10/2581; H04J 14/04

(52) U.S. Cl. CPC H04B 10/2581; H04J 14/04

(57) ABSTRACT

Embodiments of the present disclosure disclose a signal transmission method, an apparatus, and a system. The method includes: receiving, by a first mode multiplexer, a first optical signal by using each input port; generating, by the first mode multiplexer, a second optical signal according to a correspondence between the input port and a mode group, where the second optical signal is an optical signal in any mode of the mode group corresponding to the input port, and one input port corresponds to one mode group; and outputting, by the first mode multiplexer, the second optical signal. In the embodiments of the present disclosure, a transmission capacity of a single fiber is increased to implement big data transmission, thereby implementing fast transmission capacity expansion, and improving utilization of overall system bandwidth.

### CROSS-REFERENCE TO RELATED APPLICATIONS

This application is a continuation of International Application No. PCT/CN2015/087234, filed on Aug. 17, 2015, the disclosure of which is hereby incorporated by reference in its entirety.

### TECHNICAL FIELD

The present application relates to the communications field, and in particular, to a signal transmission method, an apparatus, and a system in the communications field.

### BACKGROUND

Continuous development of applications such as big data and cloud computing is accompanied with robust growth of data center, mobile bearer, and other markets. Because a relatively low-cost laser can be used when a multi-mode fiber is used, the multi-mode fiber has an advantage of low system costs, and therefore is highly competitive in short-range transmission such as a data center and a mobile bearer.

In addition, as scales of a data center and a mobile bearer network grow, to control a fiber scale, a higher requirement is imposed on a capacity of a single fiber. The prior art mainly uses a parallel system solution. For example, in a 40 Gbps, 100 Gbps, and 400 Gbps parallel system, optical signals are carried in 4, 10, and 16 parallel fibers by respectively using 4, 10, and 16 pairs of 10 Gbps, 10 Gbps, and 25 Gbps transceivers, thereby implementing 40 Gbps, 100 Gbps, and 400 Gbps network transmission. However, in this practice, multiple fibers are combined to implement large-capacity data transmission, but a transmission capacity of a single fiber is not increased. As a network capacity and rate increase, how to increase the transmission capacity of the single fiber urgently needs to be resolved.

### SUMMARY

Embodiments of the present disclosure provide a signal transmission method, an apparatus, and a system. A transmission capacity of a single fiber is increased to implement big data transmission, thereby implementing fast transmission capacity expansion, and improving utilization of overall system bandwidth.

According to a first aspect, a signal transmission method is provided, where the method includes:

receiving a first optical signal by using each input port;

generating a second optical signal according to a correspondence between the input port and a mode group, where the second optical signal is an optical signal in any mode of the mode group corresponding to the input port, and one input port corresponds to one mode group; and

outputting the second optical signal.

With reference to the first aspect, in a first possible implementation of the first aspect, the first optical signal is a multi-mode optical signal, and the method includes:

allowing, according to the correspondence between the input port and the mode group, an optical signal in any mode of the corresponding mode group to pass, to obtain the second optical signal.

With reference to the first aspect, in a second possible implementation of the first aspect, the first optical signal is a multi-mode optical signal, and the method includes:

receiving a fundamental mode optical signal of the first optical signal and filtering out a high order mode optical signal; and

converting the fundamental mode optical signal into the second optical signal according to the correspondence between the input port and the mode group, where the second optical signal is an optical signal in any mode of the mode group corresponding to the input port.

With reference to the first aspect, in a third possible implementation of the first aspect, before the receiving a first optical signal by using each input port, the method further includes:

receiving, by a second mode demultiplexer, a first optical carrier signal and performing mode demultiplexing on the first optical carrier signal, where the first optical carrier signal is a multi-mode optical carrier signal;

outputting, according to a correspondence between an output port of the second mode demultiplexer and a mode group, a second optical carrier signal in a mode of the corresponding mode group; and

modulating the second optical carrier signal to obtain the first optical signal.

With reference to the first aspect, in a fourth possible implementation of the first aspect, before the receiving a first optical signal by using each input port, the method further includes:

receiving, by a second mode demultiplexer, a first optical carrier signal and performing mode demultiplexing on the first optical carrier signal, where the first optical carrier signal is a multi-mode optical carrier signal;

outputting, according to a correspondence between an output port of the second mode demultiplexer and a mode group, a second optical carrier signal in a mode of the corresponding mode group;

converting the second optical carrier signal into a fundamental mode optical carrier signal; and

modulating the fundamental mode optical carrier signal to obtain the first optical signal.

With reference to any one of the first aspect or the first to the fourth possible implementations of the first aspect, in a fifth possible implementation of the first aspect, the mode group includes one or more optical signal modes that have same or similar propagation constants.

According to a second aspect, a signal transmission method is provided, where the method includes:

receiving and performing mode demultiplexing on second optical signals, to obtain third optical signals in multiple different modes, and then respectively converting the third optical signals into fundamental mode optical signals, and outputting the fundamental mode optical signals from first output ports of a first mode demultiplexer, where one of the first output ports corresponds to one of the modes of the third optical signals; and

outputting, according to a correspondence between a second output port of the first mode demultiplexer and a mode group and from the second output port, fundamental mode optical signals obtained after third optical signals belonging to the same mode group are converted, where one second output port corresponds to one mode group.

With reference to the second aspect, in a first possible implementation of the second aspect, the method further includes:

performing mode multiplexing on the signals that are output by the second output port.

With reference to the second aspect, in a second possible implementation of the second aspect, the mode group includes one or more optical signal modes that have same or similar propagation constants.

According to a third aspect, a first mode multiplexer is provided, including:

multiple input ports, each configured to receive a first optical signal;

a first processing unit, configured to generate a second optical signal according to a correspondence between a first input port and a mode group, where the second optical signal is an optical signal in any mode of the mode group corresponding to the first input port; and

one output port, configured to output the second optical signal.

With reference to the third aspect, in a first possible implementation of the third aspect, the first optical signal is a multi-mode optical signal, and the first processing unit allows, according to the correspondence between the first input port of the first optical signal and the mode group, an optical signal in any mode of the corresponding mode group to pass, to obtain the second optical signal.

With reference to the third aspect, in a second possible implementation of the third aspect, the first optical signal is a multi-mode optical signal, and the first processing unit receives a fundamental mode optical signal of the first optical signal and filters out a high order mode optical signal, and then converts the fundamental mode optical signal into the second optical signal according to the correspondence between the input port and the mode group, where the second optical signal is an optical signal in any mode of the mode group corresponding to the input port.

With reference to the third aspect or the first or the second possible implementation of the third aspect, in a third possible implementation of the third aspect, the mode group includes one or more optical signal modes that have same or similar propagation constants.

According to a fourth aspect, a transmitter is provided, including a laser array and the first mode multiplexer in the third aspect, where the first mode multiplexer is coupled to the laser array.

With reference to the fourth aspect, in a first possible implementation of the fourth aspect, the transmitter further includes a second mode demultiplexer and a modulator array, where each output port of the second mode demultiplexer is connected to one of modulators of the modulator array, an output port of each modulator is connected to one input port of the first mode multiplexer, and the second mode demultiplexer includes:

a fourth processing unit, configured to: demultiplex a received first optical carrier signal that is output by a laser, where the first optical carrier signal is a multi-mode optical carrier signal; and output, according to a correspondence between an output port of the second mode demultiplexer and a mode group, a second optical carrier signal in a mode of the corresponding mode group, where

the modulator array is configured to modulate the second optical carrier signal to obtain a first optical signal.

With reference to the fourth aspect, in a second possible implementation of the fourth aspect, the second mode demultiplexer includes:

a fourth processing unit, configured to: receive a first optical carrier signal and perform mode demultiplexing on the first optical carrier signal, where the first optical carrier signal is a multi-mode optical carrier signal; and output, according to a correspondence between an output port of the second mode demultiplexer and a mode group, a second optical carrier signal in a mode of the corresponding mode group; and

a second conversion unit, configured to convert the second optical carrier signal into a fundamental mode optical carrier signal, where

the modulator array is configured to modulate the fundamental mode optical carrier signal to obtain the first optical signal.

According to a fifth aspect, a first mode demultiplexer is provided, including:

one input port, configured to receive second optical signals;

a second processing unit, configured to perform mode demultiplexing on the second optical signals to obtain third optical signals in multiple different modes;

a first conversion unit, configured to respectively convert the third optical signals into fundamental mode optical signals;

multiple first output ports, configured to output the fundamental mode optical signals, where one of the first output ports corresponds to one of the modes of the third optical signals;

a third processing unit, configured to output, according to a correspondence between a second output port and a mode group and from the second output port, fundamental mode optical signals obtained after third optical signals belonging to the same mode group are converted; and

multiple second output ports, configured to output the fundamental mode optical signals, where one of the second output ports corresponds to one mode group.

With reference to the fifth aspect, in a first possible implementation of the fifth aspect, the mode group includes one or more optical signal modes that have same or similar propagation constants.

According to a sixth aspect, a receiver is provided, including the first mode demultiplexer in the fifth aspect and a photodetector array, where the first mode demultiplexer is coupled to the photodetector array.

With reference to the sixth aspect, in a first possible implementation of the sixth aspect, the receiver further includes:

a second mode multiplexer, coupled to the first mode demultiplexer, and configured to: perform mode multiplexing on signals that are output by second output ports of the first mode demultiplexer, and output, to the photodetector array by using a multi-mode waveguide, signals obtained after multiplexing.

According to a seventh aspect, a space division multiplexing system is provided, including the transmitter in the fourth aspect and the receiver in the sixth aspect.

According to an eighth aspect, a data communications apparatus is provided, where the apparatus includes: a processor, a memory, and a bus system, the processor is connected to the memory by using the bus system, the memory is configured to store an instruction, and the processor is configured to execute the instruction stored in the memory, where

the processor is configured to: receive a first optical signal; generate a second optical signal according to a correspondence between an input port and a mode group, where the second optical signal is an optical signal in any mode of the mode group corresponding to the input port; and output the second optical signal.

According to a ninth aspect, a data communications apparatus is provided, where the apparatus includes: a processor, a memory, and a bus system, the processor is connected to the memory by using the bus system, the memory is configured to store an instruction, and the processor is configured to execute the instruction stored in the memory, where

the processor is configured to: receive and perform mode demultiplexing on second optical signals, to obtain third optical signals in multiple different modes, and then respectively convert the third optical signals into fundamental mode optical signals, and output the fundamental mode optical signals from first output ports of a first mode demultiplexer, where one of the first output ports corresponds to one of the modes of the third optical signals; and output, according to a correspondence between a second output port of the first mode demultiplexer and a mode group and from the second output port, fundamental mode optical signals obtained after third optical signals belonging to the same mode group are converted, where one second output port corresponds to one mode group.

Based on the foregoing technical solutions, in the embodiments of the present disclosure, each input port of the first mode multiplexer receives the first optical signal, and the first mode multiplexer generates the second optical signal according to the correspondence between the input port and the mode group. The second optical signal is an optical signal in any mode of the mode group corresponding to the input port, and one input port corresponds to one mode group. The second optical signal is output from the output port and transmitted to the receiver by using a multi-mode fiber. In the embodiments of the present disclosure, a transmission capacity of a single fiber is increased to implement big data transmission, thereby implementing fast transmission capacity expansion, and improving utilization of overall system bandwidth.

### BRIEF DESCRIPTION OF DRAWINGS

To describe the technical solutions in the embodiments of the present disclosure more clearly, the following briefly describes the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a schematic block diagram of a space division multiplexing system according to an embodiment of the present disclosure;

FIG. 2 is a schematic block diagram of a first mode multiplexer according to an embodiment of the present disclosure;

FIG. 3 is a schematic diagram of mode group classification according to an embodiment of the present disclosure;

FIG. 4 is a schematic block diagram of another space division multiplexing system according to an embodiment of the present disclosure;

FIG. 5 is a schematic block diagram of a first mode demultiplexer according to an embodiment of the present disclosure;

FIG. 6 is a schematic block diagram of another first mode demultiplexer according to an embodiment of the present disclosure;

FIG. 7 is a schematic block diagram of another space division multiplexing system according to an embodiment of the present disclosure;

FIG. 8 is a schematic flowchart of a data communication method according to an embodiment of the present disclosure;

FIG. 9 is another schematic flowchart of a data communication method according to an embodiment of the present disclosure;

FIG. 10 is a schematic block diagram of a data communications apparatus according to an embodiment of the present disclosure; and

FIG. 11 is another schematic block diagram of a data communications apparatus according to an embodiment of the present disclosure.

### DESCRIPTION OF EMBODIMENTS

The following clearly describes the technical solutions in the embodiments of the present disclosure with reference to the accompanying drawings in the embodiments of the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

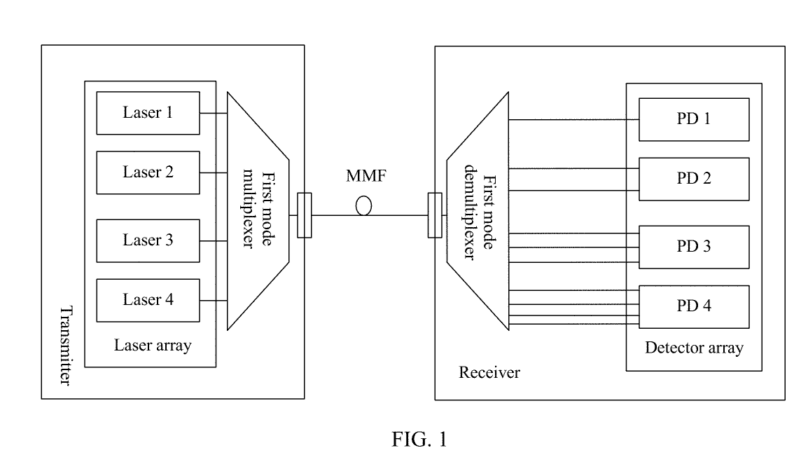

FIG. 1 is a schematic block diagram of a system according to an embodiment of the present disclosure. As shown in FIG. 1, the system is a space division multiplexing (SDM) system based on a multi-mode fiber, and includes a transmitter and a receiver. The transmitter includes a laser array (or multiple lasers, both are referred to as a laser array below) and a first mode multiplexer. The receiver includes a first mode demultiplexer and a detector array (or multiple detectors, both are referred to as a detector array below). The transmitter is connected to the receiver by using one multi-mode fiber (MMF). The first mode multiplexer performs mode conversion on optical signals transmitted by lasers in the laser array and multiplexes, in a mode group multiplexing manner, the optical signals to the multi-mode fiber between the first mode multiplexer and the first mode demultiplexer. The first mode demultiplexer receives the optical signals from the multi-mode fiber, and performs mode conversion on the received signals and demultiplexes the signals to waveguides connected to the first mode demultiplexer, to send the signals to the detector array for optical-to-electrical conversion and data receiving.

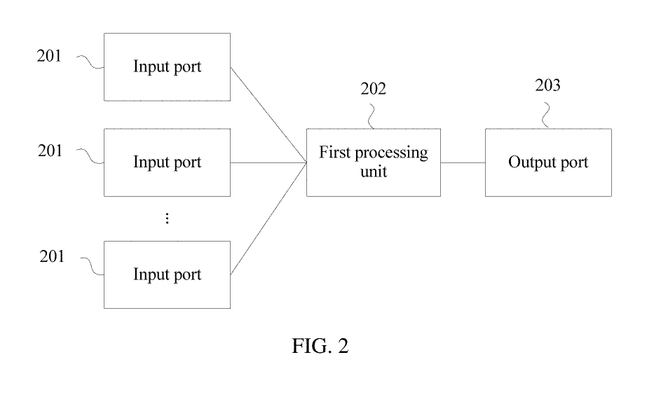

As shown in FIG. 1, the transmitter includes the laser array and the first mode multiplexer. As shown in FIG. 2, the first mode multiplexer has X (X≥2 and X is a natural number) input ports 201, a first processing unit 202, and one output port 203. X is a quantity of channels of an optical module that support mode multiplexing. The input ports 201 are coupled to the laser array, and the output port 203 is coupled to the multi-mode fiber. The input ports 201 may be coupled to the laser array in a spatial coupling manner or by using a multi-mode fiber or a multi-mode waveguide or single-mode waveguides. The multiple input ports 201 are each configured to receive a first optical signal. The first processing unit 202 is configured to generate a second optical signal according to a correspondence between the input port 201 and a mode group. The second optical signal is an optical signal of any mode of the mode group corresponding to the input port 201. The second optical signal is output from the unique output port 203 and transmitted to the receiver by using the multi-mode fiber.

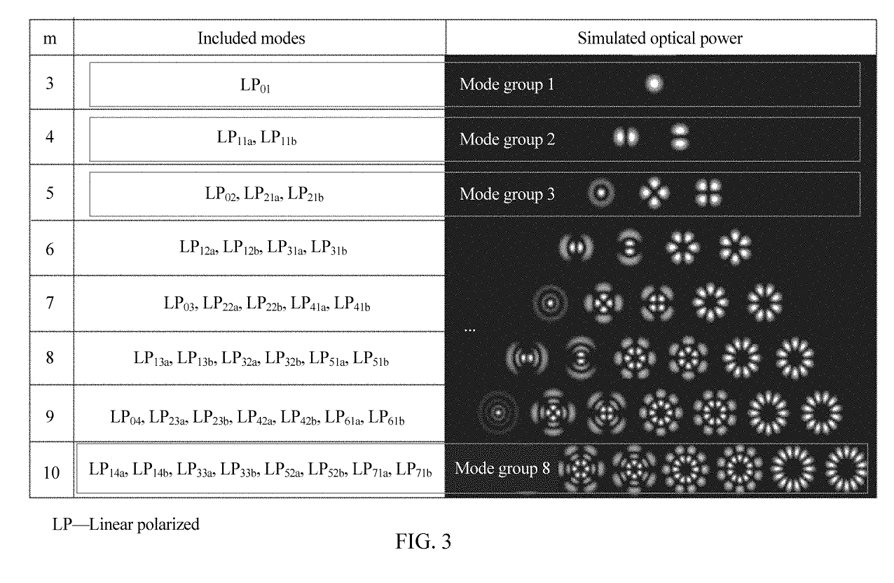

As shown in FIG. 3, different optical signal modes are classified into multiple mode groups in advance in the system. All the mode groups are different from each other. Each mode group is used as a whole to carry one optical signal, and each mode group may include one or more optical signal modes that have same or similar propagation constants. For example, an optical signal mode LP01 is classified into a mode group 1, that is, the mode group 1 includes an optical signal whose mode is LP01; LP11a and LP11b are classified into a mode group 2; modes LP02, LP21a, and LP21b are classified into a mode group 3, and so on.

The first mode multiplexer converts an LP01 mode signal received by a first input port into an LP01 mode optical signal, converts an LP01 mode signal received by a second input port into a signal in either mode of LP11a and LP11b, converts an LP01 mode signal received by a third input port into a signal in any mode of LP02, LP21a, or LP21b, converts an LP01 mode signal received by a fourth input port into a signal in any mode of LP12a, LP12b, LP31a, or LP31b, and so on.

Specifically, when the laser is a multi-transverse-mode laser (the first optical signal is a multi-mode optical signal), the first processing unit 202 allows, according to the correspondence between the input port 201 and the mode group, an optical signal in any mode of the corresponding mode group to pass, to obtain the second optical signal. Alternatively, the input port 201 receives a fundamental mode optical signal of the first optical signal and filters out a high order mode optical signal. The first processing unit 202 converts the fundamental mode optical signal into the second optical signal according to the correspondence between the input port 201 and the mode group. The second optical signal is an optical signal in any mode of the mode group corresponding to the input port 201. The second optical signal is output from the unique output port 203 and transmitted to the receiver by using the multi-mode fiber.

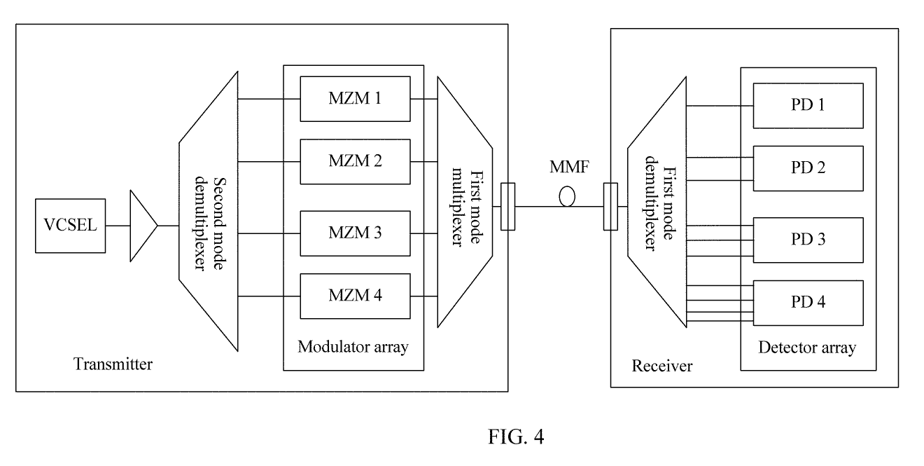

Alternatively, as shown in FIG. 4, the transmitter includes a laser, a second mode demultiplexer, a modulator array, and a first mode multiplexer. The laser array generates optical carrier signals in multiple modes. The laser is an ordinary VCSEL laser. The second mode demultiplexer includes one input port and N output ports. Each output port of the second mode demultiplexer is connected to one of modulators of the modulator array, and an output port of each modulator is connected to one input port of the first mode multiplexer. Each output port of the second mode demultiplexer is connected to one modulator, and a signal that is output by the output port is modulated by the modulator, and carries data information that needs to be sent to a peer receive end. Specifically, each modulator has one optical input port, one optical output port, and one electrical signal control interface. Each modulator receives electrical signal data, modulates a received optical signal, and outputs an optical signal that carries data information. The optical output port of each modulator is connected to one input port of the first mode multiplexer. In this way, coupling is performed in a multi-mode manner (by using space, a multi-mode waveguide, or a multi-mode fiber) between the second mode demultiplexer and the input port of the modulator, and between the output port of the modulator and the first mode multiplexer. It should be understood that, the modulator also needs to be capable of supporting fundamental mode and high order mode modulation.

Specifically, in a first case, the second mode demultiplexer includes:

a fourth processing unit, configured to: demultiplex a received first optical carrier signal that is output by the laser, where the first optical carrier signal is a multi-mode optical carrier signal; and output, according to a correspondence between an output port of the second mode demultiplexer and a mode group, a second optical carrier signal in a mode of the corresponding mode group. For example, a first output port of the second mode demultiplexer outputs an LP01 mode signal, a second output port of the second mode demultiplexer outputs a signal in either mode of a second mode group (LP11a, LP11b), a third output port of the second mode demultiplexer outputs a signal in any mode of a third mode group (LP02, LP21a, LP21b), a fourth output port of the second mode demultiplexer outputs a signal in any mode of a fourth mode group (LP12a, LP12b, LP31a, LP31b), and so on. The modulator array is configured to modulate the second optical carrier signal to obtain the first optical signal. X optical signals (X mode group signals) modulated by N modulators respectively reach X input ports of the first mode multiplexer, and are multiplexed inside the first mode multiplexer to the output port. The signals are multiplexed into optical signals carrying multiple mode group signals, output from the output port, coupled to the multi-mode fiber, and further transmitted to the receiver.

As shown in FIG. 4, in a second case, the second mode demultiplexer demultiplexes received multi-transverse-mode optical signals that are output by lasers, and further performs mode conversion on the demultiplexed signals, to convert the signals into fundamental mode LP01 signals, and outputs an LP01 mode signal from each port. Specifically, the second mode demultiplexer includes: a fourth processing unit, configured to: receive a first optical carrier signal and perform mode demultiplexing on the first optical carrier signal, where the first optical carrier signal is a multi-mode optical carrier signal; and output, according to a correspondence between an output port of the second mode demultiplexer and a mode group, a second optical carrier signal in a mode of the corresponding mode group; and a second conversion unit, configured to convert the second optical carrier signal into a fundamental mode optical carrier signal. The modulator array is configured to modulate the fundamental mode optical carrier signal to obtain the first optical signal. For example, an LP01 mode signal that is output by a first output port of the second mode demultiplexer corresponds to an LP01 mode signal in multiple mode signals received by the input port; an LP01 mode signal that is output by a second output port of the second mode demultiplexer corresponds to a signal in either one or a combination of a second mode group (LP11a, LP11b) in the multiple mode signals received by the input port; an LP01 mode signal that is output by a third output port of the second mode demultiplexer corresponds to a signal in any one or a combination of a third mode group (LP02, LP21a, LP21b) in the multiple mode signals received by the input port; an LP01 mode signal that is output by a fourth output port of the second mode demultiplexer corresponds to a signal in any one or a combination of a fourth mode group (LP12a, LP12b, LP31a, LP31b) in the multiple mode signals received by the input port, and so on.

Each output port of the second mode demultiplexer is connected to one modulator (or the output port of the second mode demultiplexer is connected to the modulator array), and a signal that is output by the output port of the second mode demultiplexer is modulated by the modulator, and carries data information that needs to be sent to a peer receive end. X optical signals (X mode group signals) modulated by X modulators respectively reach X input ports of the first mode multiplexer, and are multiplexed inside the first mode multiplexer to the output port. The signals are multiplexed into optical signals carrying multiple mode group signals, output from the output port, coupled to the multi-mode fiber, and further transmitted to the receiver. In this way, coupling is performed in a single-mode manner (by using space, a single-mode waveguide, or a single-mode fiber) between the second mode demultiplexer and the input port of the modulator, and between the output port of the modulator and the first mode multiplexer. Each modulator in the modulator array supports fundamental mode (LP01 mode) optical signal modulation.

Further, a first optical amplifier may be included between the laser array and the second mode demultiplexer, to amplify optical signals that are output by the laser array. Optionally, the output port of the first mode multiplexer may be connected to a second optical amplifier, to amplify, by using the second optical amplifier, multiple mode signals that have been multiplexed and that carry modulated data.

The present disclosure discloses the transmitter. Each input port of the first mode multiplexer receives the first optical signal. The first mode multiplexer generates the second optical signal according to the correspondence between the input port and the mode group. The second optical signal is an optical signal in any mode of the mode group corresponding to the input port, and one input port corresponds to one mode group. The second optical signal is output from the unique output port and transmitted to the receiver by using the multi-mode fiber. A transmission capacity of a single fiber is increased to implement big data transmission, thereby implementing fast transmission capacity expansion, and improving utilization of overall system bandwidth.

As shown in FIG. 1 and FIG. 4, the receiver includes the first mode demultiplexer and the detector array. The first mode demultiplexer has one input port and M (M≥2 and M is a natural number) first output ports. The input port is coupled to the multi-mode fiber, and can receive second optical signals in multiple modes. Each of the M first output ports outputs an optical signal in one mode, and in this case, the first output port is a single-mode waveguide. Further, the M first output ports are grouped into N (N≥2 and N is a natural number) second output ports. The N second output ports are configured to be coupled to N detectors or configured to send the received optical signals to the photodetector array on a receiving side. The N second output ports are grouped in a mode group manner. N is less than M. The first mode demultiplexer is configured to demultiplex the received signals in the multiple modes, convert an optical signal in each mode into a fundamental mode LP01 mode signal, and output the fundamental mode LP01 mode signal to one corresponding output port of the M first output ports. Using M=10 as an example for description, the first mode demultiplexer demultiplexes received signals in 10 modes (LP01, LP11a, LP11b, LP02, LP21a, LP21b, LP12a, LP12b, LP31a, LP31b), converts the signals into LP01 signals, and output the LP01 signals to a first port, a second port, . . . , and a tenth port of the M first output ports. The first port corresponds to an LP01 fundamental mode signal in the input port, the second port corresponds to an LP11a signal in the input port, . . . , and the tenth port corresponds to an LP31b signal in the input port. The M first output ports are grouped in a manner of 1, 2, 3, 4, that is, a first group (a 1st second output port) includes the first port of the first output ports, a second group (a 2nd second output port) includes the second port and a third port (two ports in total) of the first output ports, a third group (a 3rd second output port) includes a fourth port, a fifth port, and a sixth port (three ports in total) of the first output ports, and a fourth group (a 4th second output port) includes a seventh port, an eighth port, a ninth port, and the tenth port (four ports in total) of the first output ports. Each second output port corresponds to one photodetector.

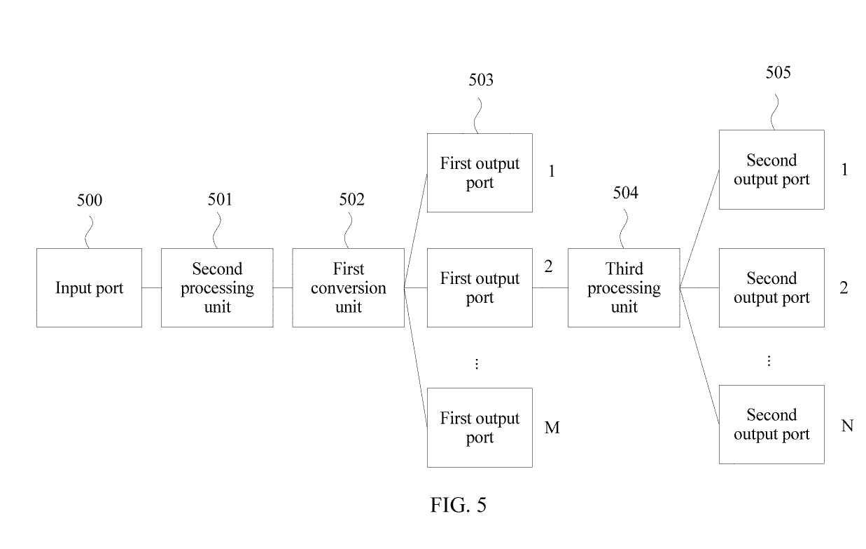

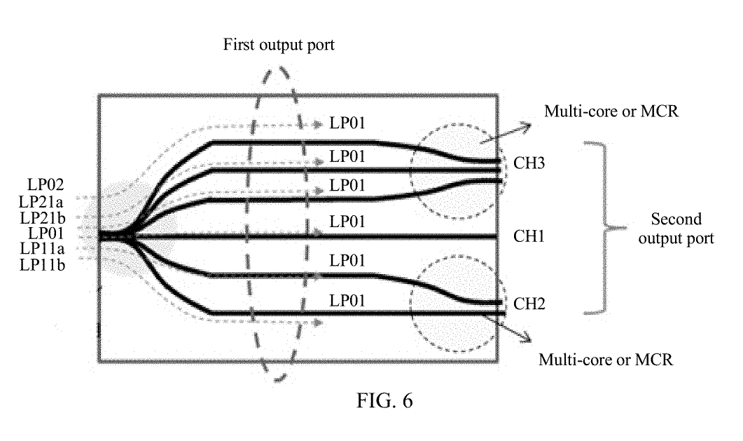

FIG. 5 is a schematic structural diagram of a first mode demultiplexer according to an embodiment of the present disclosure. As shown in FIG. 5, the first mode demultiplexer includes:

one input port 500, configured to receive second optical signals;

a second processing unit 501, configured to perform mode demultiplexing on the second optical signals to obtain third optical signals in multiple different modes;

a first conversion unit 502, configured to respectively convert the third optical signals into fundamental mode optical signals;

multiple first output ports 503, configured to output the fundamental mode optical signals, where one of the first output ports corresponds to one of the modes of the third optical signals;

a third processing unit 504, configured to output, according to a correspondence between a second output port and a mode group and from the second output port, fundamental mode optical signals obtained after third optical signals belonging to the same mode group are converted; and

multiple second output ports 505, configured to output the fundamental mode optical signals, where one of the second output ports corresponds to one mode group.

In this embodiment, the signals that are output by the second output ports are output to the photodetector array by using single-mode waveguides.

Similarly, the mode group includes one or more optical signal modes that have same or similar propagation constants.

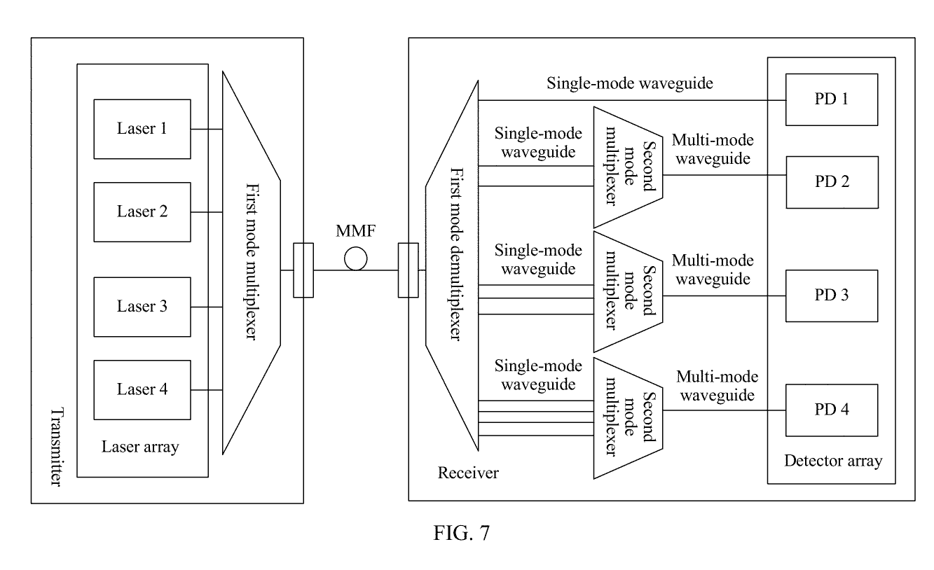

As shown in FIG. 7, the receiver further includes: a second mode multiplexer, coupled to the first mode demultiplexer, and configured to: perform mode multiplexing on signals that are output by a 2^{nd} second output port to an (N−1) ^{th} second output port 505 of the first mode demultiplexer, and output, to the photodetector array by using a multi-mode waveguide, signals obtained after multiplexing. There are M−1 second mode multiplexers, that is, one less than the M first output ports of the first mode demultiplexer.

The first mode demultiplexer receives and performs mode demultiplexing on the second optical signals, to obtain the third optical signals in the multiple different modes, and then respectively converts the third optical signals into fundamental mode optical signals, and outputs the fundamental mode optical signals from the first output ports of the first mode demultiplexer. One of the first output ports corresponds to one of the modes of the third optical signals. The first mode demultiplexer then outputs, according to the correspondence between the second output port of the first mode demultiplexer and the mode group and from the second output port, the fundamental mode optical signals obtained after the third optical signals belonging to the same mode group are converted. One second output port corresponds to one mode group. A transmission capacity of a single fiber is increased to implement big data transmission, thereby implementing fast transmission capacity expansion, and improving utilization of overall system bandwidth.

As shown in FIG. 1, the present disclosure further discloses a space division multiplexing system including at least a transmitter and a receiver. The transmitter includes a laser array and a first mode multiplexer. The first mode multiplexer has X input ports and one output port. The input ports are coupled to lasers. The input ports may be coupled to the lasers in a spatial coupling manner or by using a multi-mode fiber or a multi-mode waveguide. The receiver includes a first mode demultiplexer and a detector array. The first mode demultiplexer has one input port and M first output ports. The input port is configured to be coupled to a multi-mode fiber, and can receive optical signals in multiple modes. Each of the M first output ports outputs an optical signal in one mode. Further, the M first output ports are grouped into N second output ports, and the N second output ports are configured to be coupled to N detectors. The N second output ports are grouped in a mode group manner. The first mode multiplexer may include functions shown in the apparatus diagram FIG. 2, and the first mode demultiplexer includes functions shown in FIG. 5. Details are as follows:

The first mode multiplexer is configured to: receive a first optical signal by using each input port; generate a second optical signal according to a correspondence between the input port and a mode group, where the second optical signal is an optical signal in any mode of the mode group corresponding to the input port, and one input port corresponds to one mode group; and output the second optical signal.

The first mode demultiplexer is configured to: receive and perform mode demultiplexing on second optical signals, to obtain third optical signals in multiple different modes, and then respectively convert the third optical signals into fundamental mode optical signals, and output the fundamental mode optical signals from the first output ports of the first mode demultiplexer, where one of the first output ports corresponds to one of the modes of the third optical signals; and output, according to a correspondence between a second output port of the first mode demultiplexer and a mode group and from the second output port, fundamental mode optical signals obtained after third optical signals belonging to the same mode group are converted, where one second output port corresponds to one mode group. In this embodiment, the signals that are output by the second output port are output to the photodetector array by using a single-mode waveguide.

Refer to the foregoing descriptions of the embodiments corresponding to the apparatus diagrams FIG. 2 to FIG. 5 for details, which are not described herein again.

In this embodiment of the present disclosure, the first mode multiplexer receives the first optical signal by using each input port; generates the second optical signal according to the correspondence between the input port and the mode group, where the second optical signal is an optical signal in any mode of the mode group corresponding to the input port, and one input port corresponds to one mode group; and outputs the second optical signal. Finally, the second optical signal obtained after conversion is multiplexed to the multi-mode fiber for transmission. The first mode demultiplexer receives and performs mode demultiplexing on the second optical signals, to obtain the third optical signals in the multiple different modes, and then respectively converts the third optical signals into the fundamental mode optical signals, and outputs the fundamental mode optical signals from the first output ports of the first mode demultiplexer, where one of the first output ports corresponds to one of the modes of the third optical signals; and outputs, according to the correspondence between the second output port of the first mode demultiplexer and the mode group and from the second output port, the fundamental mode optical signals obtained after the third optical signals belonging to the same mode group are converted, where one second output port corresponds to one mode group. In this embodiment of the present disclosure, an existing fiber of a data center does not need to be changed, and a transmission capacity of a single fiber is increased to implement big data transmission, thereby implementing fast transmission capacity expansion, and improving utilization of overall system bandwidth.

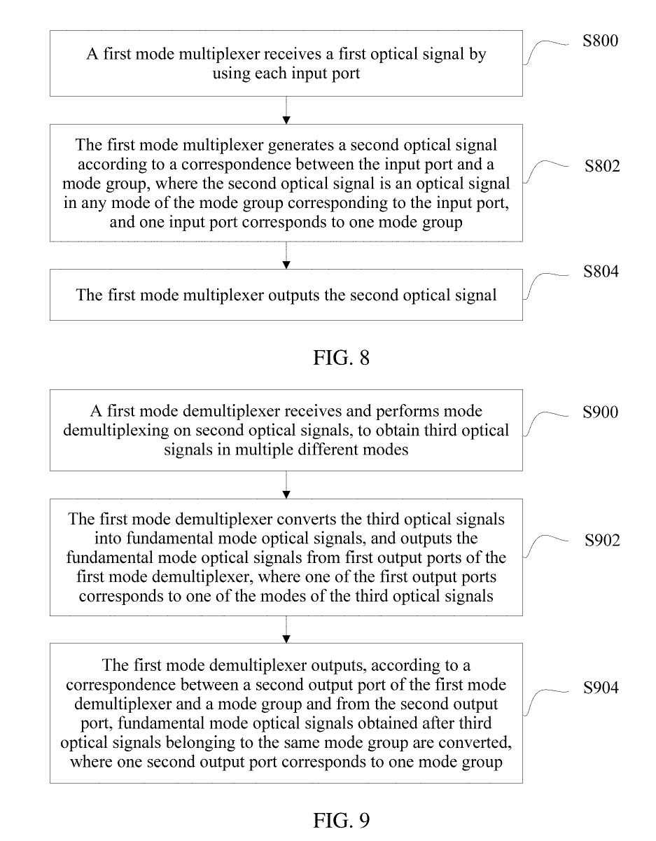

As shown in FIG. 8, FIG. 8 is a schematic flowchart of a signal transmission method according to an embodiment of the present disclosure. The method may be performed by a data communications apparatus, for example, the first mode multiplexer shown in FIG. 2. The signal transmission method may be applied to a networking architecture diagram of FIG. 1 or FIG. 4. As shown in FIG. 7, the method includes the following steps.

S800. A first mode multiplexer receives a first optical signal by using each input port.

S802. The first mode multiplexer generates a second optical signal according to a correspondence between the input port and a mode group, where the second optical signal is an optical signal in any mode of the mode group corresponding to the input port, and one input port corresponds to one mode group.

Specifically, in a first case, a second mode demultiplexer includes:

a fourth processing unit, configured to: demultiplex a received first optical carrier signal that is output by a laser, where the first optical carrier signal is a multi-mode optical carrier signal; and output, according to a correspondence between an output port of the second mode demultiplexer and a mode group, a second optical carrier signal in a mode of the corresponding mode group. For example, a first output port of the second mode demultiplexer outputs an LP01 mode signal, a second output port of the second mode demultiplexer outputs a signal in either mode of a second mode group (LP11a, LP11b), a third output port of the second mode demultiplexer outputs a signal in any mode of a third mode group (LP02, LP21a, LP21b), a fourth output port of the second mode demultiplexer outputs a signal in any mode of a fourth mode group (LP12a, LP12b, LP31a, LP31b), and so on. A modulator array is configured to modulate the second optical carrier signal to obtain the first optical signal. X optical signals (X mode group signals) modulated by X modulators respectively reach X input ports of the first mode multiplexer, and are multiplexed inside the first mode multiplexer to an output port. The signals are multiplexed into optical signals carrying multiple mode group signals, output from the output port, coupled to the multi-mode fiber, and further transmitted to a receiver.

As shown in FIG. 4, in a second case, a second mode demultiplexer demultiplexes received multi-transverse-mode optical signals that are output by lasers, and further performs mode conversion on the demultiplexed signals, to convert the signals into fundamental mode LP01 signals, and outputs an LP01 mode signal from each port. Specifically, the second mode demultiplexer includes: a fourth processing unit, configured to: receive a first optical carrier signal and perform mode demultiplexing on the first optical carrier signal, where the first optical carrier signal is a multi-mode optical carrier signal; and output, according to a correspondence between an output port of the second mode demultiplexer and a mode group, a second optical carrier signal in a mode of the corresponding mode group; and a second conversion unit, configured to convert the second optical carrier signal into a fundamental mode optical carrier signal. A modulator array is configured to modulate the fundamental mode optical carrier signal to obtain the first optical signal. For example, an LP01 mode signal that is output by a first output port of the second mode demultiplexer corresponds to an LP01 mode signal in multiple mode signals received by the input port; an LP01 mode signal that is output by a second output port of the second mode demultiplexer corresponds to a signal in either one or a combination of a second mode group (LP11a, LP11b) in the multiple mode signals received by the input port; an LP01 mode signal that is output by a third output port of the second mode demultiplexer corresponds to a signal in any one or a combination of a third mode group (LP02, LP21a, LP21b) in the multiple mode signals received by the input port; an LP01 mode signal that is output by a fourth output port of the second mode demultiplexer corresponds to a signal in any one or a combination of a fourth mode group (LP12a, LP12b, LP31a, LP31b) in the multiple mode signals received by the input port, and so on.

Each output port of the second mode demultiplexer is connected to one modulator (or the output port of the second mode demultiplexer is connected to the modulator array), and a signal that is output by the output port of the second mode demultiplexer is modulated by the modulator, and carries data information that needs to be sent to a peer receive end. X optical signals (X mode group signals) modulated by X modulators respectively reach X input ports of the first mode multiplexer, and are multiplexed inside the first mode multiplexer to an output port. The signals are multiplexed into optical signals carrying multiple mode group signals, output from the output port, coupled to a multi-mode fiber, and further transmitted to a receiver. In this way, coupling is performed in a single-mode manner (by using space, a single-mode waveguide, or a single-mode fiber) between the second mode demultiplexer and an input port of a modulator, and between an output port of the modulator and the first mode multiplexer. Each modulator in the modulator array supports fundamental mode (LP01 mode) optical signal modulation.

S804. The first mode multiplexer outputs the second optical signal.

The first mode multiplexer receives the first optical signal by using each input port. The first mode multiplexer generates the second optical signal according to the correspondence between the input port and the mode group. The second optical signal is an optical signal in any mode of the mode group corresponding to the input port, and one input port corresponds to one mode group. The second optical signal is output from the output port and transmitted to the receiver by using the multi-mode fiber. A transmission capacity of a single fiber is increased to implement big data transmission, thereby implementing fast transmission capacity expansion, and improving utilization of overall system bandwidth.

FIG. 9 is a schematic flowchart of a signal transmission method according to an embodiment of the present disclosure. The method may be performed by a data communications apparatus, for example, the mode demultiplexer shown in FIG. 5. The signal transmission method may be applied to a networking architecture diagram of FIG. 1 or FIG. 4. As shown in FIG. 9, the method includes the following steps:

S900. A first mode demultiplexer receives and performs mode demultiplexing on second optical signals, to obtain third optical signals in multiple different modes.

S902. The first mode demultiplexer converts the third optical signals into fundamental mode optical signals, and outputs the fundamental mode optical signals from first output ports of the first mode demultiplexer, where one of the first output ports corresponds to one of the modes of the third optical signals.

S904. The first mode demultiplexer outputs, according to a correspondence between a second output port of the first mode demultiplexer and a mode group and from the second output port, fundamental mode optical signals obtained after third optical signals belonging to the same mode group are converted, where one second output port corresponds to one mode group.

Further, another embodiment further includes a step of performing mode multiplexing on the signals that are output by the second output port, and signals obtained after multiplexing are output to a photodetector array by using a multi-mode waveguide.

The mode group includes one or more optical signal modes that have same or similar propagation constants.

The present disclosure discloses the signal transmission method. The first mode demultiplexer receives and performs mode demultiplexing on the second optical signals, to obtain the third optical signals in the multiple different modes. Then the first mode demultiplexer converts the third optical signals into the fundamental mode optical signals, and outputs the fundamental mode optical signals from the first output ports of the first mode demultiplexer. One of the first output ports corresponds to one of the modes of the third optical signals. The first mode demultiplexer then outputs, according to the correspondence between the second output port of the first mode demultiplexer and the mode group and from the second output port, the fundamental mode optical signals obtained after the third optical signals belonging to the same mode group are converted. One second output port corresponds to one mode group. A transmission capacity of a single fiber is increased to implement big data transmission, thereby implementing fast transmission capacity expansion, and improving utilization of overall system bandwidth.

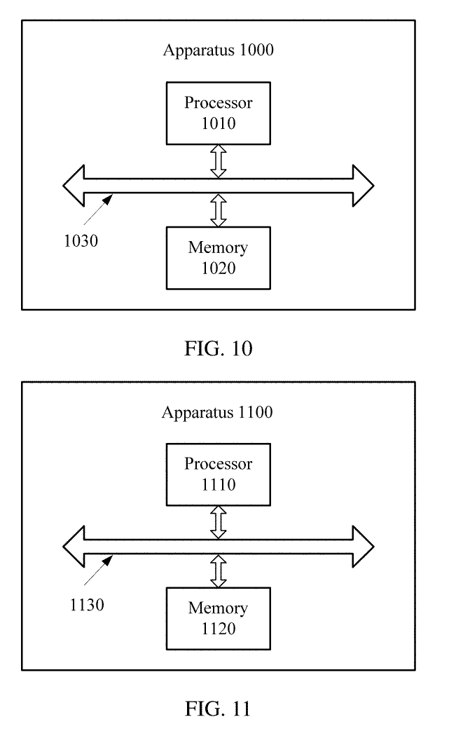

As shown in FIG. 10, an embodiment of the present disclosure further provides a data communications apparatus 1000. The apparatus 1000 includes a processor 1010, a memory 1020, and a bus system 1030, the processor 1010 is connected to the memory 1020 by using the bus system 1030, the memory 1020 is configured to store an instruction, and the processor 1010 is configured to execute the instruction stored in the memory 1020.

The processor 1010 is configured to: receive a first optical signal; generate a second optical signal according to a correspondence between an input port and a mode group, where the second optical signal is an optical signal in any mode of the mode group corresponding to the input port; and output the second optical signal.

As shown in FIG. 11, an embodiment of the present disclosure further provides a data communications apparatus 1100. The apparatus 1100 includes a processor 1110, a memory 1120, and a bus system 1130, the processor 1110 is connected to the memory 1120 by using the bus system 1130, the memory 1120 is configured to store an instruction, and the processor 1110 is configured to execute the instruction stored in the memory 1120.

The processor 1110 is configured to: receive and perform mode demultiplexing on second optical signals, to obtain third optical signals in multiple different modes, and then respectively convert the third optical signals into fundamental mode optical signals, and output the fundamental mode optical signals from first output ports of a first mode demultiplexer, where one of the first output ports corresponds to one of the modes of the third optical signals; and output, according to a correspondence between a second output port of the first mode demultiplexer and a mode group and from the second output port, fundamental mode optical signals obtained after third optical signals belonging to the same mode group are converted, where one second output port corresponds to one mode group.

For specific procedures performed by the processors 1010 and 1110, refer to descriptions corresponding to the flowcharts shown in FIG. 8 and FIG. 9. Details are not described herein again.

It should be understood that, in this embodiment of the present disclosure, the processor 1010 maybe a central processing unit (CPU), or the processor 1010 may be another general-purpose processor, a digital signal processor (DSP), an application-specific integrated circuit (ASIC), a field-programmable gate array (FPGA) or another programmable logical device, discrete gate or transistor logical device, discrete hardware component, or the like. The general-purpose processor may be a microprocessor or the processor may be any conventional processor or the like.

The memory 1020 may include a read-only memory and a random access memory, and provides an instruction and data for the processor 1010. A part of the memory 1020 may further include a non-volatile random access memory. For example, the memory 1020 may further store device type information.

The bus system 1030 may include a power bus, a control bus, a status signal bus, and the like in addition to a data bus. However, for the purpose of clear description, all buses are marked as the bus system 1030 in the figure.

In an implementation process, steps of the foregoing methods maybe accomplished by using an integrated logical circuit of hardware in the processor 1010 or an instruction in a form of software. Steps of the method disclosed with reference to the embodiments of the present disclosure may be directly performed and completed by means of a hardware processor, or may be performed and completed by using a combination of hardware and software modules in the processor. The software module may be located in a mature storage medium in the art, such as a random access memory, a flash memory, a read-only memory, a programmable read-only memory, an electrically-erasable programmable memory, or a register. The storage medium is located in the memory 1020, and the processor 1010 reads information in the memory 1020 and completes the steps of the foregoing methods in combination with hardware of the processor 1010. To avoid repetition, details are not described herein again.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

It should be understood that in the embodiments of the present disclosure, “B corresponding to A” indicates that B is associated with A, and B may be determined according to A. However, it should further be understood that determining A according to B does not mean that B is determined according to A only; that is, B may also be determined according to A and/or other information.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for ease and brevity of description, for a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, the unit division is merely logical function division and may be other division in actual implementation. For example, a plurality of units or components maybe combined or integrated into another system, or some features may be ignored or not performed. In addition, the displayed or discussed mutual couplings or direct couplings or communication connections may be implemented through some interfaces, indirect couplings or communication connections between the apparatuses or units, or electrical connections, mechanical connections, or connections in other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present disclosure essentially, or the part contributing to the prior art, or all or some of the technical solutions may be implemented in the form of a software product. The software product is stored in a storage medium and includes several instructions for instructing a computer device (which may be a personal computer, a server, or a network device) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The foregoing descriptions are merely specific embodiments of the present disclosure, but are not intended to limit the protection scope of the present disclosure. Any modification or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A signal transmission method, comprising:
receiving a first optical signal at an input port;
generating a second optical signal according to a correspondence between the input port and a mode group, wherein the second optical signal is an optical signal in any mode of the mode group corresponding to the input port, and one input port corresponds to one mode group; and
outputting the second optical signal.

2. The signal transmission method according to claim 1, wherein the first optical signal is a multi-mode optical signal, and the method comprises:
allowing, according to the correspondence between the input port and the mode group, an optical signal in any mode of the corresponding mode group to pass, to obtain the second optical signal.

3. The signal transmission method according to claim 1, wherein the first optical signal is a multi-mode optical signal, and the method comprises:
receiving a fundamental mode optical signal of the first optical signal and filtering out a high order mode optical signal; and
converting the fundamental mode optical signal into the second optical signal according to the correspondence between the input port and the mode group, wherein the second optical signal is an optical signal in any mode of the mode group corresponding to the input port.

4. The signal transmission method according to claim 1, wherein before receiving a first optical signal at an input port, the method further comprises:
receiving, by a second mode demultiplexer, a first optical carrier signal and performing mode demultiplexing on the first optical carrier signal, wherein the first optical carrier signal is a multi-mode optical carrier signal;
outputting, according to a correspondence between an output port of the second mode demultiplexer and a mode group, a second optical carrier signal in a mode of the corresponding mode group; and
modulating the second optical carrier signal to obtain the first optical signal.

5. The signal transmission method according to claim 1, wherein before receiving a first optical signal by using each input port, further comprising:
receiving, by a second mode demultiplexer, a first optical carrier signal and performing mode demultiplexing on the first optical carrier signal, wherein the first optical carrier signal is a multi-mode optical carrier signal;
outputting, according to a correspondence between an output port of the second mode demultiplexer and a mode group, a second optical carrier signal in a mode of the corresponding mode group;
converting the second optical carrier signal into a fundamental mode optical carrier signal; and
modulating the fundamental mode optical carrier signal to obtain the first optical signal.

6. The signal transmission method according to claim 1, wherein the mode group comprises one or more optical signal modes that have same or similar propagation constants.

7. A signal transmission method, comprising:
receiving and performing mode demultiplexing on second optical signals, to obtain third optical signals in multiple different modes;
respectively converting the third optical signals into fundamental mode optical signals;
outputting the fundamental mode optical signals from first output ports of a first mode demultiplexer, wherein one of the first output ports corresponds to one of the modes of the third optical signals; and
outputting from a second output of the first mode demultiplexer, according to a correspondence between the second output port and a mode group, fundamental mode optical signals obtained after third optical signals belonging to the same mode group are converted, wherein one second output port corresponds to one mode group.

8. The signal transmission method according to claim 7, further comprising:
performing mode multiplexing on the fundamental mode optical signals output by the second output port.

9. The signal transmission method according to claim 7, wherein the mode group comprises one or more optical signal modes that have same or similar propagation constants.

10. A first mode multiplexer, comprising:
multiple input ports, each configured to receive a first optical signal;
a first processing unit, configured to generate a second optical signal according to a correspondence between a first input port and a mode group, wherein the second optical signal is an optical signal in any mode of the mode group corresponding to the first input port; and
an output port, configured to output the second optical signal.

11. The first mode multiplexer according to claim 10, wherein the first optical signal is a multi-mode optical signal, and the first processing unit is configured to:
allow, according to the correspondence between the first input port of the first optical signal and the mode group, an optical signal in any mode of the corresponding mode group to pass, to obtain the second optical signal.

12. The first mode multiplexer according to claim 10, wherein the first optical signal is a multi-mode optical signal, and the first processing unit is configured to:
receive a fundamental mode optical signal of the first optical signal and filter out a high order mode optical signal; and
convert the fundamental mode optical signal into the second optical signal according to the correspondence between the input port and the mode group, wherein the second optical signal is an optical signal in any mode of the mode group corresponding to the input port.

13. The first mode multiplexer according to claim 10, wherein the mode group comprises one or more optical signal modes that have same or similar propagation constants.
